(19) United States
(12) Patent Application Publication
(10) Pub. No.: US 2003/0135378 A1
(43) Pub. Date: Jul. 17, 2003

(54) Method and system for reporting, assigning, and tracking facilities incident reports

(75) Inventors: Leif Carlson, Vancouver, WA (US); Tony Feliciano, Vancouver, WA (US); Michael M. Robinson, Vancouver, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SEH America, Inc.

(21) Appl. No.: 10/044,739

(22) Filed: Jan. 11, 2002

(51) Int. Cl. G06F 17/60

(52) U.S. Cl. 705/1

(57) ABSTRACT

A method and system for reporting, assigning, and tracking facilities incident reports provides a single integrated approach to maintaining incident reports. Incident reports that affect personnel, production, equipment or the environment are reported via a computer network. Supervisors are notified of the incident report and assign corrective action. Other relevant personnel are notified of the incident report to classify the incident and complete corrective action.

### FIELD OF THE INVENTION

The present invention relates generally to methods and systems of industrial facilities management, and more particularly, to a method and system for reporting, assigning, and tracking facilities incident reports and environmental incident reports.

### BACKGROUND OF THE INVENTION

In order to monitor and control modern industrial processes, facilities management systems have been developed. One such process requiring attention by facilities managers includes managing incidents which could have an impact on production, personnel, equipment, or the environment. Effective organization and management of these incidents is essential to sustaining productive work centers, maintaining quality control, and preserving efficient production processes.

Awareness of environmental incidents, in particular, has become quite acute recently due to governmental regulation, governmental oversight, and increased civil liability. Therefore, industrial facilities managers are now establishing environmental awareness goals for various departments and divisions. As such, many industries have begun to require the departments and divisions to devote more attention and effort to correcting environmental incidents, as well as incidents affecting equipment, production or personnel.

More particularly, training programs and prevention programs are often implemented to achieve management's goals. These training programs and prevention programs are often developed with generic techniques to achieve uniform training and prevention across an entire company, department, or division. These generic programs are most often general in nature, and only address the most obvious and generally applicable hazards and problems. They often fail to take into account many specific industrial hazards unique to a particular facility. Additionally, many divisions and departments may have similar hazards and problems common to other departments and divisions, yet they may not be hazards and problems that are generally applicable to an entire company, department, or division. Thus, it is difficult to train for and prevent these hazards and problems in generic training and prevention programs.

There are occasions when a specific incident is important enough that it attracts senior management attention. These incidents might spur corrective action that includes requests for incident reports, immediate remedial action, and incorporation into the facilities training program. Quick response corrective actions to high attention incidents provide immediate relief, and thus satisfy the facilities management supervisor's immediate need to know that the incident is receiving the attention that it deserves. Unfortunately, the high attention incidents gradually fade from the forefront of management's concerns as they are replaced by other more urgent concerns. Similarly, the long term assigned corrective action likewise diminishes from the forefront of attention and responsibility for corrective actions is passed on or forgotten. For example, training programs with an assigned corrective action often move on to address other high priority concerns and leave the previous incidents behind. Also, the incident reports that were filed relating to high attention incidents are filed away only to be forgotten as they become buried under more and more incident reports. Similarly, as supervisory and production personnel turnover to newer personnel, the incidents, training, prevention, and corrective actions fade from community knowledge. Such a situation thus reduces the probability of preventing similar incidents in the future.

There are, additionally, those incidents that do not receive heightened awareness at senior management level and often go unreported. These lesser and unreported incidents include the small scale incidents that affect only a small group of people who take immediate steps to prevent the problems and hazards creating the incident among their circle of co-workers. Others in a particular division or department may be affected by similar hazards or problems that lead to such incidents. Of course, the new knowledge of the small group would be beneficial for prevention of incidents in these similarly affected groups, yet the knowledge never leaves the bounds of that small group, and the other similarly affected groups never increase their probability of preventing similar incidents.

Additionally, some industrial facilities have developed committees and collaterally delegated incident supervision duties to personnel to keep abreast of current incident reports and the status of their corrective actions. These committees and personnel have begun to address some of the problems described above. They review incidents, assign corrective action, keep ticklers to remind themselves of corrective action in progress, and perhaps even review follow up actions of particularly serious incidents. Of course as more and more incidents, projects, and other duties increase, time allocation to tracking incident reports is diminished. Also, each person may have her own way to track and report incidents that differ from another person's methods and systems. This may lead to miscommunication, unreported incidents, and disparate and contradictory incident prioritizing throughout a company, department, or division. Through no fault of their own, these committees and collaterally delegated personnel will ultimately suffer from many of the same problems described above.

Particular note should be made of environmental incidents, which face the same dilemma described more generally above. Environmental incidents, however, run a broader gamut from mundane incidents to serious incidents with criminal and civil liability concerns. Additionally, seemingly mundane environmental incidents, if not immediately corrected and prevented, often have a probability of growing into more serious environmental incidents. Furthermore, governmental regulation and oversight often requires the reporting of environmental incidents to governmental authority and particular corrective action which may be designated by statute, regulation, or government agency directive. For these reasons, the above described limitations and problems associated with reporting, tracking, and correcting incidents are particularly acute with respect to environmental incidents.

Thus, there is a need for a method and system for reporting, tracking, and assigning facility incident reports. More particularly, a method and system are required that may be uniformly implemented and available to all similarly affected personnel to train for and prevent similar incidents across a company, department, or division.

### SUMMARY OF THE INVENTION

To meet the above and other needs, an automated method and system for reporting, assigning, and tracking facility incident reports, are therefore provided. In one advantageous embodiment, an initial incident report is initially received that identifies an incident, such as an environmental incident. An electronic report notification is then automatically provided to various authorities in the company, division, or department requiring notification of the incident. These may include a supervisory authority and an incident classification authority.

The incident classification authority classifies the incident according to an incident classification standard so as to standardize incident management. The incident classification is typically based upon the severity of harm caused as a result of the incident. Oftentimes the incident classification authority is an environmental monitoring committee or division. In cases of environmental incidents, the classification is often a governmentally directed classification standard required to be used when reporting environmental incidents to the appropriate government authority. The classification is appropriately recorded in the incident report and stored in the computer database.

The supervisory authority typically includes facilities supervisors and managers. The appropriate supervisory authority has the responsibility for determining corrective actions and assigning the corrective action to designated personnel, such as division managers. Some designated personnel, like division managers, may also have supervisory authority and therefore assign specific tasks to additional designated personnel. These designated personnel are assigned corrective actions and both the corrective actions and designated personnel are recorded in the incident report and stored in the computer database.

All of the designated personnel are appropriately and automatically notified of the incident report so that they may access and review the incident report to review the assigned corrective action. Whereupon, the assigned personnel complete the assigned corrective action and record the completion of the corrective action in the incident report in the computer database.

One embodiment of the present invention provides for assigning due dates to the corrective actions. As such, designated personnel may review and complete their corrective actions by the due date. If the corrective actions are not completed by the due date, an electronic notification is automatically provided to the designated personnel after the due date to remind them of the overdue corrective action. The notification can also be sent to the supervisory authority.

Upon the recording of the completion of the assigned corrective action it may be advantageous to provide a completed action notification of the incident report to the supervisory authority, preferably in an automated and electronic fashion. At such time, the supervisory authority may review the assigned corrective action to ensure that the corrective action was satisfactory prior to closing out the report. In one advantageous embodiment, the supervisory authority may determine if further corrective action is necessary and then repeat the process by assigning further corrective action to designated personnel.

One advantageous embodiment of the present invention selectively limits access to the incident reports by selected personnel. For example, there may be particularly sensitive incidents which should not be available to all users with access to the computer database. Also, some reports may limit access at various stages of the incident report recording to provide for specific management of the incident until certain selected aspects have been completed, such as assigning corrective actions.

Additionally, an automated system is provided for correspondingly reporting, assigning, and tracking facilities incident reports. One aspect of the advantageous system includes a computer network and a computer database connected to the computer network for storing incident reports. The computer network is typically a local area network, a wide area network or an intranet. The system also generally includes personal computers, workstations, or other computing devices connected to the network to provide various user interfaces. One such user interface is an incident reporting user interface for receiving a facilities incident report from personnel who have knowledge of an incident and for transmitting the facilities incident report via the computer network to the computer database.

Another user interface is the supervisory user interface, which allows an appropriate supervisory authority to review the incident report and record one or more assigned corrective actions to the incident report in the computer database. The assigned corrective actions designate personnel to complete the corrective action.

Consequently, a corrective action user interface is also provided to allow the designated personnel to access and review the incident report to determine what actions they are required to accomplish. Additionally, they also use the corrective action user interface to record completion of the assigned corrective action.

Another user interface is the incident classification user interface which provides for review of the incident report and recording of an incident classification. Typically, those who review the incident classification are personnel assigned to monitor environmental incidents and, on some occasions, report the incidents to government authority. The incident classification is generally selected according to a severity of harm caused by the incident. In many cases this may be a governmentally directed standard.

In describing the foregoing user interfaces, it is apparent that certain user interfaces are primarily used by particular personnel. Therefore, one advantageous embodiment of the invention provides a user login identification code which must be entered to access a respective user interface. Thus, the computer network can provide limited access to certain users based on their identification codes.

In order to alert each of the foregoing user interfaces, the system preferably includes an electronic notification generator to provide automatic notification of the incident report to the appropriate user interfaces. These notifications include a notification to the supervisory user interface upon the recording of an incident. Also, a notification is sent to the classification user interface upon a recording of an incident. Other notifications include a notification to the corrective action user interface upon the recording of designated personnel to complete the assigned corrective action. One advantageous embodiment of the present invention uses the notification generator to provide an overdue notification to selected personnel when a corrective action is not completed and the due date has past. Typically, the electronic notification generator transmits the notifications in the form of electronic mail.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating the operations performed by the method according to one embodiment of the present invention;

FIG. 2 is a block diagram illustrating the components of the system according to one embodiment of the present invention;

FIGS. 3, 4, and 5 are an exemplary display provided by a user interface which provide fields of entry for reporting an incident report according to one embodiment of the present invention;

FIGS. 6 and 7 are an exemplary display provided by a user interface which provide a report of an incident according to one embodiment of the present invention;

FIG. 8 is an exemplary display provided by a user interface which permits entry of various parameters used to perform a database search according to one embodiment of the present invention;

FIG. 9 is an exemplary display provided by a user which provides the results of a search according to incident status according to one embodiment of the present invention;

FIG. 10 is an exemplary display provided by a user which provides selected incidents relevant to the particular user identified according to a login identification code according to one embodiment of the present invention;

FIG. 11 is an exemplary display provided by a user which provides a listing of incidents reported on a particular day according to one embodiment of the present invention;

FIG. 12 is an exemplary display provided by a user which provides a listing of incident reports with overdue corrective actions according to one embodiment of the present invention; and

FIG. 13 is an exemplary display provided by a user which provides a listing of incident reports with outstanding corrective actions according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

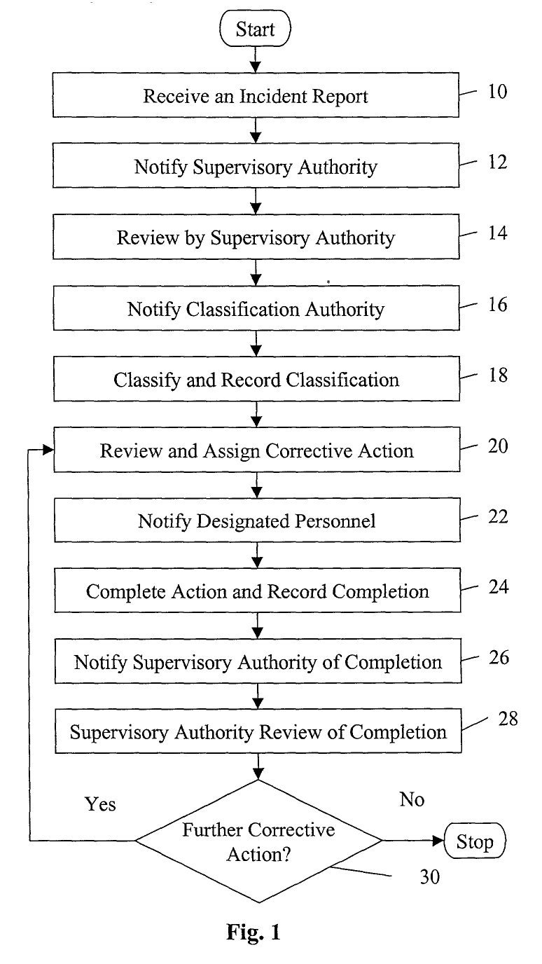

Referring now to FIG. 1, an automated facilities management method for reporting, assigning, and tracking incident reports is illustrated by a block diagram according to one embodiment of the present invention. The herein described incident reports typically relate to industrial facilities incidents involving production, personnel, equipment or the environment. Such incidents are generally the result of problems and hazards causing an unexpected or undesirable result relating to production, personnel, equipment, or the environment. An incident report is originated by a person with knowledge of the incident who records the incident which is then stored in a computer database, see block 10. This normally includes production personnel involved in the incident and management personnel who supervise the processes, systems, or facilities areas affected by the incident. The incident report will typically provide the relevant description, issues, and considerations related to the incident. For example, an incident report may include the date, time, and location of the incident; the personnel, systems, and equipment involved; a summary of the events of the incident; a description of immediate corrective actions taken; an identification of harm or possible harm to personnel, production, equipment, or the environment; an identification of the probable cause of the incident; and other such relevant considerations that may be required or desired.

Upon the reporting of an incident report, relevant supervisory authority are automatically notified of the incident report, see block 12, by means of an electronic notification. These personnel may include the supervisors of the personnel involved and managers of the systems or equipment affected. The supervisory authority reviews the sufficiency of the report, and makes necessary additions and conclusions to the report, such as determining the root cause of the incident, see block 14. Additionally, the supervisory authority is also responsible for determining appropriate corrective action relating to the incident report and assigning corrective action to designated personnel, see block 20. Selecting the required corrective actions is generally a matter of choice according to management goals and objectives. For example, corrective actions may include repair of the affected equipment, development of new methods to prevent incidents, increased monitoring of the affected systems, and incorporation of prevention techniques into training programs. Many other corrective actions will come to mind as specific incidents generate new and creative methods for dealing with incidents. All of these new and creative corrective actions may be added to the incident report for assignment to designated personnel. Additionally, it is often desirable to provide due dates for corrective actions. The supervisory authority can assign due dates with each corrective action and, as described below, can be notified upon passage of the due date if the corrective action is not complete.

Once the supervisory authority reviews the incident report and it is deemed satisfactory, a classification authority is automatically notified, also typically by an electronic notification, to classify the incident according to a classification standard, see blocks 16 and 18. The classification authority is typically distinct from the supervisory authority, particularly when relating to matters of environmental concern. In many industries, designated environmental monitoring and reporting personnel are assembled to track and report environmental incidents. Oftentimes, environmental incidents raise issues relating to governmental regulations and reporting. As governmental regulation and oversight has become more and more complex, industries have designated environmental personnel and delegated more and more authority to them. As such, environmental personnel are typically the classification authority with respect to environmental incidents.

Additionally, the environmental personnel may also comprise part or all of the supervisory authority, depending on each facilities particular management hierarchy. Alternatively, with respect to facilities that do not designate environmental personnel and with respect to incidents that do not relate to environmental harm, the classification authority may be coincident with the supervisory authority for centralization of the process.

The designated personnel that are assigned corrective action are then automatically notified of the incident report so that they may review the incident report in the computer database, see block 22. Typically, this notification is provided electronically. A review of the entire incident report allows the designated personnel to determine their appropriate duties with respect to the incident and the scope of the actions that need to be taken. Upon completion of the corrective actions, the designated personnel record the completion of the corrective action and this additional information is typically stored in the computer database, see block 24. When completion of the corrective actions are recorded, the supervisory authority is once again notified, see block 26, in an automated electronic fashion. The supervisory authority can review the incident report to determine the adequacy of the corrective actions and whether or not to assign further corrective action or to close the incident report, see blocks 28 and 30.

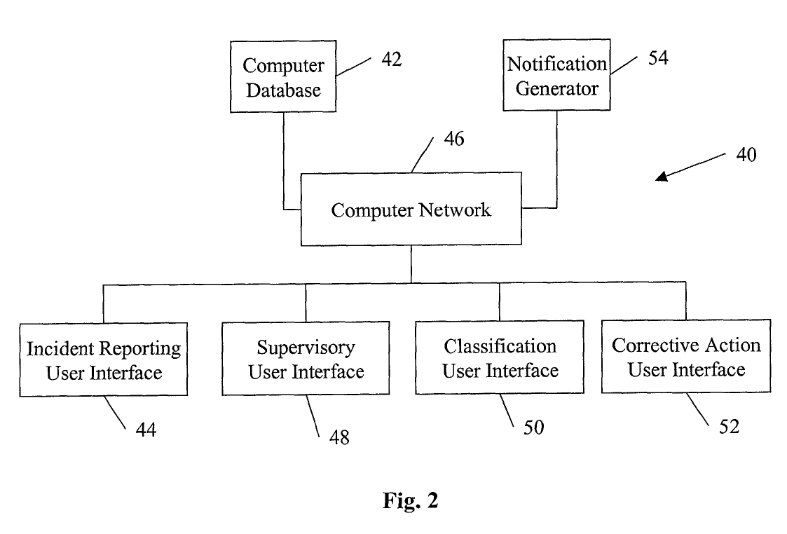

Referring now to FIG. 2, a system 40 is illustrated according to another embodiment of the present invention. The system 40 includes a computer network 46 with a computer database 42 for storing an incident report and related information. The computer network 46 is typically accessed through a variety of user interfaces 44, 48, 50, 52, as described below. Each user interface 44, 48, 50, 52, may be provided by a personal computer, workstation, or other computing device connected to the computer network for the transmitting of data therewith.

By way of example, an incident report is entered though an incident reporting user interface 44. The incident reporting user interface 44 may be accessed by a person with knowledge of the incident, such as a person involved in the incident or the managers of a system affected by a particular incident. The incident reporting user interface 44 typically provides for reporting the relevant description, issues, and considerations related to the incident. For example, an incident report may include the date, time, and location of the incident; the personnel, systems, and equipment involved; a summary of the events of the incident; a description of immediate corrective actions taken; an identification of harm or possible harm to personnel, production, equipment, or the environment; an identification of the probable cause of the incident; and other such relevant considerations that may be required or desired. Once the incident is documented, the incident report is typically stored and the supervisory authority is notified, preferably in an automated and electronic fashion.

The notification is generally provided to the supervisory authority by means of an electronic message transmitted to a supervisory user interface. In addition to notification, the supervisory user interface 48 allows review of the incident by the supervisory authority, such as supervisors of the personnel involved or supervisors of the particular systems and facilities affected. The incident report in the computer database 42 is reviewed through the supervisory user interface 48 and provides for recording additions to the relevant description of the incident and recording appropriate conclusions relating to the incident, such as recording the root cause of the incident. Additionally, the supervisory user interface 48 also provides for recording appropriate corrective action, due dates for the corrective action, and assigning designated personnel to be assigned corrective action. The supervisory user interface 48 may be used again to regularly follow up and track the incident report and the status of completing corrective action by the designated personnel.

Once the supervisory authority have reviewed an incident report, the incident report is classified. As such, the classification authority is generally notified in an automated and electronic manner, typically by means of an electronic message transmitted to a classification user interface 50. The classification user interface 50 is also connected to the computer network 46 and, in addition to receiving notification of the pending incident report, provides for recording a classification of the incident to the incident report, which classification is then also stored in the computer database 42. Classification of the incident may relate to an environmental classification related to the harm caused to the environment. Often these classifications are governmentally directed standards required for use when reporting certain environmental incidents to the government. Other embodiments of the classification user interface 50 include providing incident classification relating to the severity of the harm caused to production, equipment, or personnel, which is correspondingly recorded within or otherwise associated with or appended to the incident report in the computer database 42. The classification user interface 50 may be used again to regularly follow up and track the incident report and the status of completing corrective action.

Once the supervisory authority has assigned corrective action and designated personnel to perform the corrective action and further once the classification authority has classified the incident, the designated personnel are notified such that the corrective action may commence. The designated personnel are advantageously notified by means of an electronic notification that is automatically transmitted to a corrective action user interface associated with the designated personnel. A corrective action user interface 52 is connected to the computer network 46 and, in addition to receiving the electronic notification of the corrective action assigned to the designated personnel, also allows the designated personnel to access and review the incident report in the computer database 42. The designated personnel review the incident report through the corrective action user interface 52 to determine the appropriate corrective actions to be completed. Upon completion, the corrective action user interface 52 is once again used by designated personnel to access the incident report in the computer database 42 and record the completion of the corrective actions to the incident report. Additionally, designated personnel may use the corrective action user interface 52 to regularly review, track and update the status of an incident and corrective action.

The system 40 also advantageously includes a notification generator 54, such as a processing element typically embodied by a personal computer, a workstation, or the like, connected to the computer network 46 for providing the notifications to selected user interfaces, generally in an automated electronic fashion as described above. In one advantageous embodiment of the present invention, the notification generator 54 provides notification to the supervisory user interface 48 upon the recording of an incident report in the computer database 42, thus alerting supervisory personnel to a new incident. Additionally, the classification user interface 50 is also notified via the notification generator 54 upon the recording of an incident in the database 42. Thus, the classification authority is alerted to the new incident requiring classification. The notification generator 54 may also alert the designated personnel via the corrective action user interface 52 once a corrective action has been assigned by the supervisory authority. The notification generator may alert the designated personnel and the supervisory authority when the corrective action due date passes and the corrective action is not completed such that appropriate follow up measures may be taken. Furthermore, the notification generator may alert the supervisory authority via the supervisory user interface once the designated personnel indicate that the corrective action has been completed.

For purposes of discussion, the method and system of the present invention are described in conjunction with a computer network 42, such as a local area network, a wide area network, an intranet, or the like, and associated user interfaces. More specifically, the various displays represented by the user interfaces and described below are generally defined by hypertext markup language documents. However, the method and system for reporting, tracking, and assigning incident reports can be employed in conjunction with other electronic database systems or computer systems without departing from the spirit or scope of the present invention.

By way of example, however, the system includes a computer network that may, in turn, include a local area network, a wide area network incorporating several local area networks, or an intranet, and a plurality of personal computers that serve as respective user interfaces which interact via the computer network. Personal computers include software for facilitating the user interface, such as database access programs, electronic mail programs, and hypertext markup language (HTML) document browsing programs. Additionally, the computer network 46 facilitates the storing and controlling of information in computer databases, which are commonly accessed at the personal computer user interfaces. One exemplary embodiment of the present invention includes using and creating HTML documents in the database 42 for access by HTML browsing software at the user interface 44, 48, 50, 52.

Login identification codes may be associated with one or more of the user interfaces 44, 48, 50, 52. Many computer networks 46 restrict access to the computer network 46 by assigning login identification codes to each authorized user. The user of the computer network then provides the login identification code to the computer network in order to be granted access, usually via a respective personal computer. These login identification codes not only provide access but also allow the computer network 46 to define particular individualized parameters related to each person's access. More specifically, a particular software program may be configured to allow only particular login identification codes, and consequently only particular users, access to the supervisory user interface 44. Thus, the login identification code limits access to the supervisory user interface 48 according to the particular user. Similarly, the login identification codes may be used to identify the user accessing the system via the other user interfaces 44, 48, 50, 52, including the incident reporting user interface 44, the incident classification user interface 50, and the corrective action user interface 50. Thus, certain personnel are selected and known by the computer network 46 according to their login identification codes such that access may be provided to these personnel via a respective user interface 44, 48, 50, 52. Moreover, different personnel may be permitted to access different ones of the user interfaces by defining the permissible login identification codes separately for each user interface.

Another advantageous embodiment of the present invention also uses the login identification codes to restrict access to selected incident reports. Typically an incident report must be approved by supervisory authority prior to general dissemination of the report to other personnel. As described above, each of the above user interfaces 44, 48, 50, 52 generally provide review of the incident report, however, review may be limited to only certain stages of the completeness of the report. As such, a particular event will trigger the accessibility of the incident report beyond a predefined access list maintained by the computer network 46. For example, the incident report may be available only for review by the supervisory authority prior to assigning and recording corrective action. Therefore, users who are not part of the supervisory authority, such as the designated personnel for completing corrective action, will not be provided access to review the incident report until completion of the review by the supervisory authority, at which time a lager group of users may have access to the incident report.

One embodiment of the invention comprises providing the previously described notifications via electronic mail. Upon a predetermined action, the notification generator 54 will automatically send electronic mail to the required personnel. For example, when the supervisory authority assigns corrective actions to designated personnel, the notification generator 54 will automatically provide a preformatted electronic mail document to the designated personnel according to their login identification codes. This is most readily accomplished via HTML applications that integrate electronic mail applications.

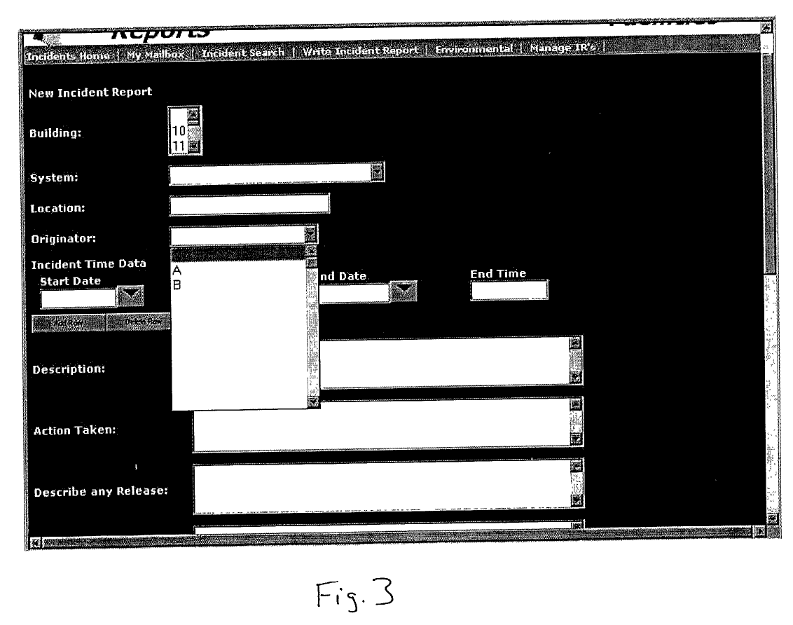

Turning now to a specific illustration of one aspect of the present invention, FIG. 3 illustrates the display provided by an incident reporting user interface 44 that provides an interactive HTML interface for reporting an incident. As is shown, the reporting of an incident may be implemented by predefining several fields of entry. These include providing a field of entry for the building where the incident occurred, the system and location affected, the incident report originator's identification, and the date of the incident report. “Pop-down” menus that include common parameters, such as originator's names as shown, are used to facilitate more efficient reporting.

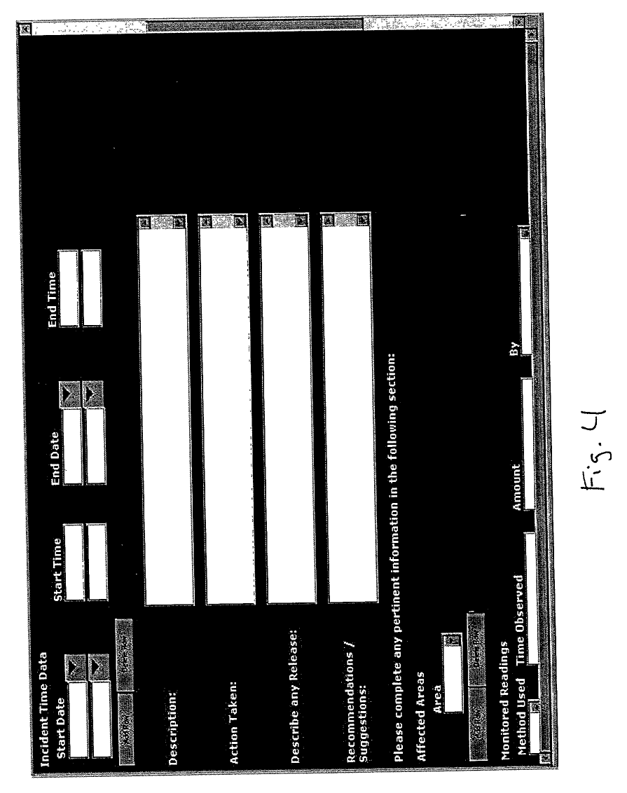

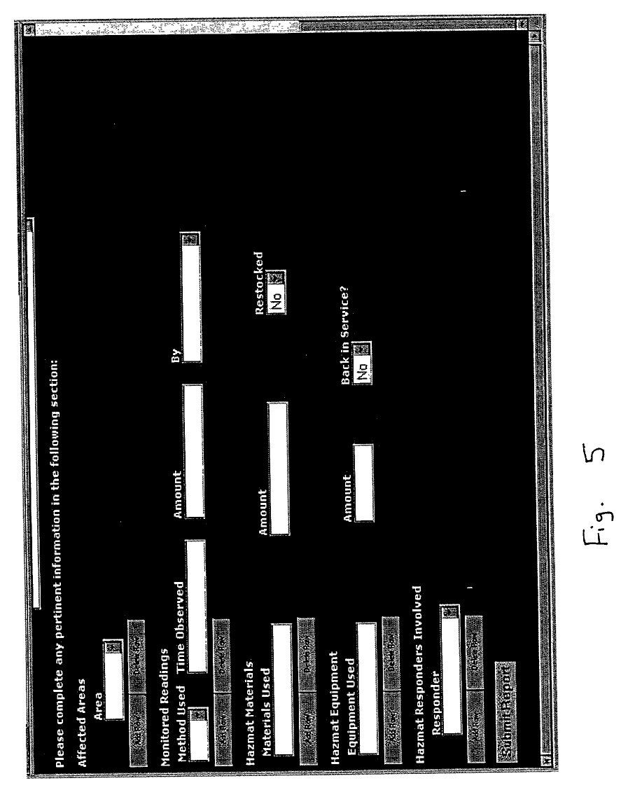

As shown in FIG. 4, which illustrates additional fields of entry in the display provided by the incident reporting user interface 44, other fields are open to provide for recording comments and descriptions of the incident at length, including actions taken at the incident, possible releases of hazardous substances, and recommendations by the originator. FIG. 5 also illustrates additional examples relating to fields of entry that may be selected depending upon the unique requirements of each incident or varied according to the particular requirements of an industrial facility.

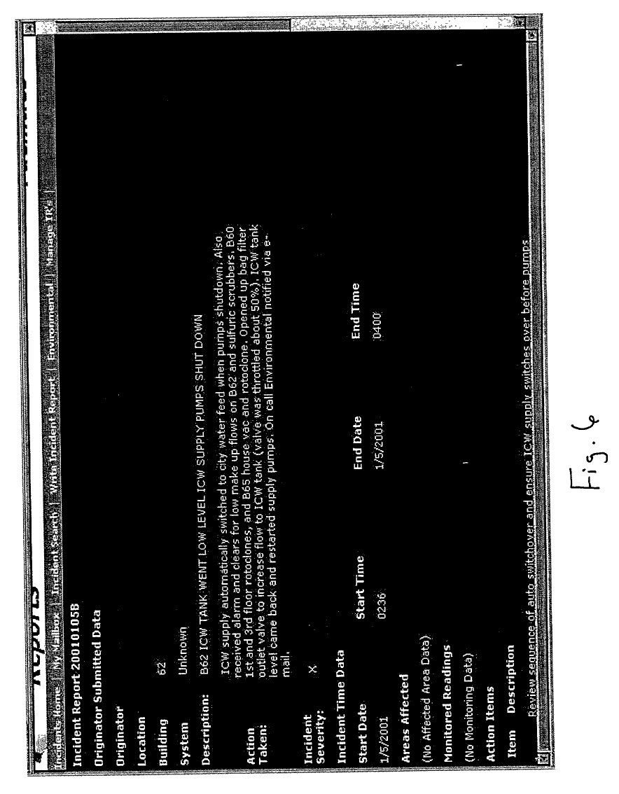

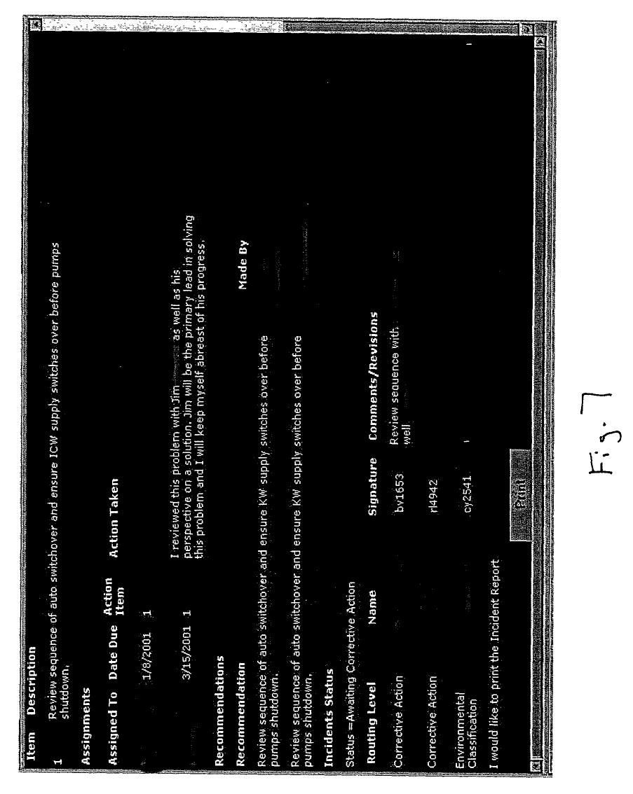

FIGS. 6 and 7 illustrate a completed incident report display outlining the various completed fields by different users, such as the supervisory authority and classification authority. The format of the incident report may be the same for display by each of the user interfaces 44, 48, 50, 52. For example, FIG. 6 demonstrates the additional incident classification next to the term “Incident Severity”, which was entered by the classification authority. “Action Items” and “Assignments” represent the required corrective action and designated personnel to complete the corrective action, and are provided via the supervisory user interface. The status of the incident report, i.e. the stage of its progress through steps of the method, is also depicted under “Incident Status”, as for example “Awaiting Corrective Action”.

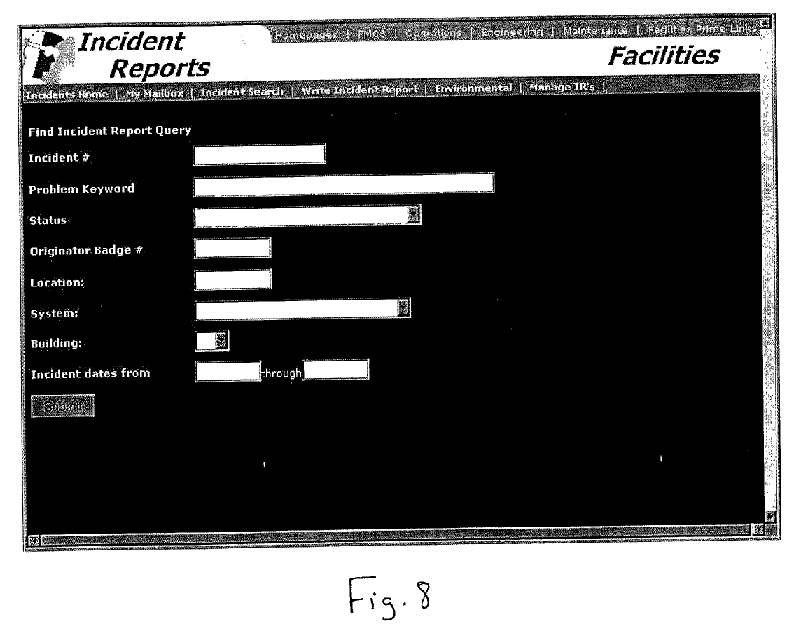

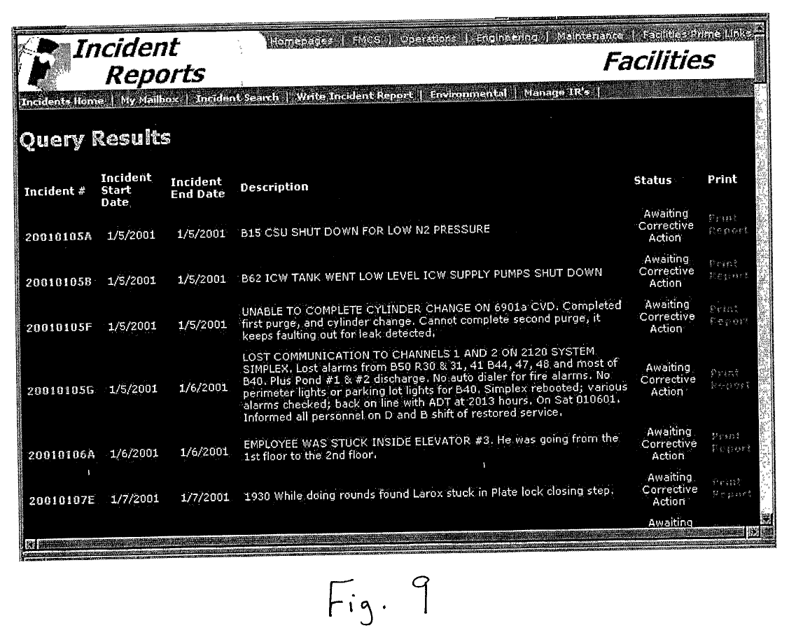

It is also advantageous to permit users to search for and list various incident reports via the user interfaces 44, 48, 50, 52. As such, the system also advantageously includes a processing element, such as a personal computer, workstation, or the like, for receiving the search criteria input by the user and then correspondingly examining the computer database to identify incidents matching the search criteria. In this regard, FIG. 8 illustrates a search scheme providing personnel with predefined parameters for creating a list of incidents meeting user selected criteria. The format of the search scheme illustrated will be the same for each of the user interfaces 44, 48, 50, 52 provided. For example, personnel may search for a listing of incident reports by incident number, problem keyword, incident status, originator number, location of the incident, the system affected by the incident, the building affected by the incident, and the dates of the incident. The search scheme provides an opportunity for personnel to review current and previous reports. This data is often used to identify incident reports with outstanding corrective actions, to determine commonalties among incident reports for cross referencing, and assess relationships between incidents of a same system and location. For example, FIG. 9 represents a resultant search listing incident reports that are awaiting corrective action. Additionally, the search may used to list resolved incidents with certain commonalties that may be further used to assess training programs, assess prevention programs, identify recurrent problems, and sharing information with related departments or divisions.

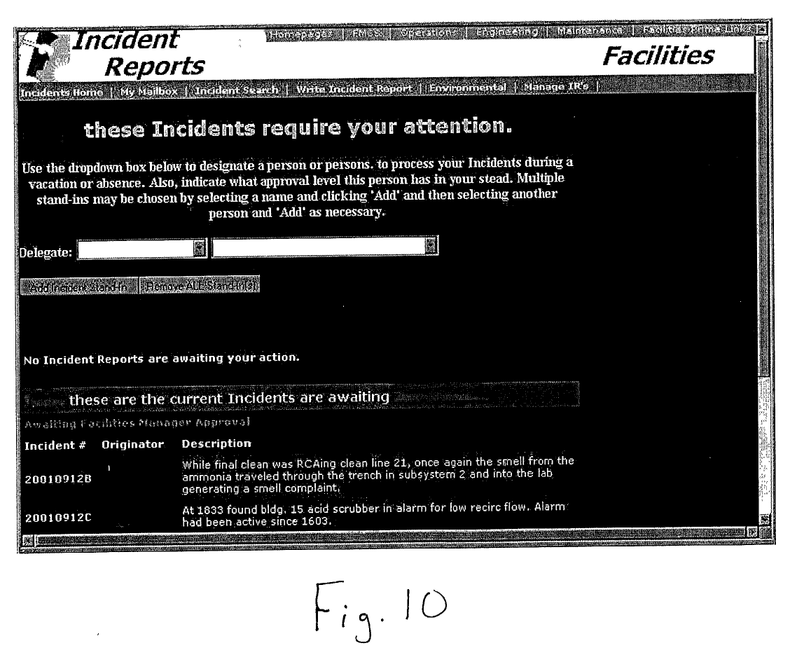

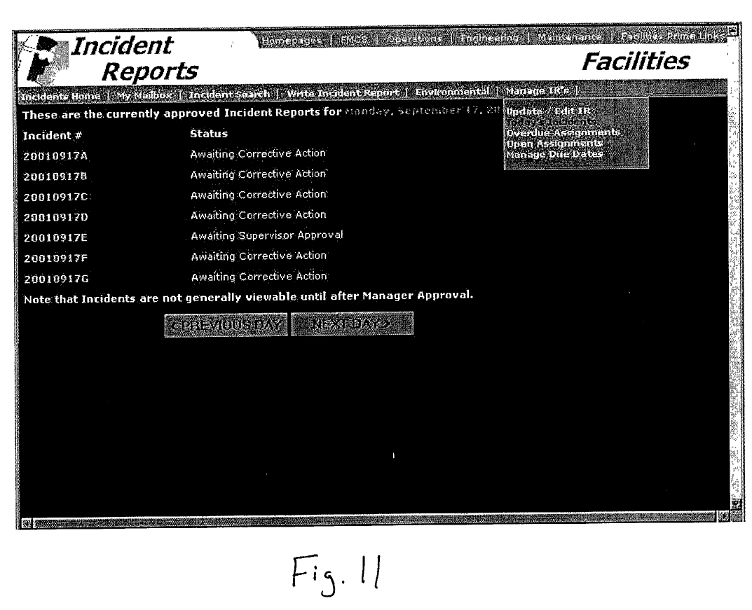

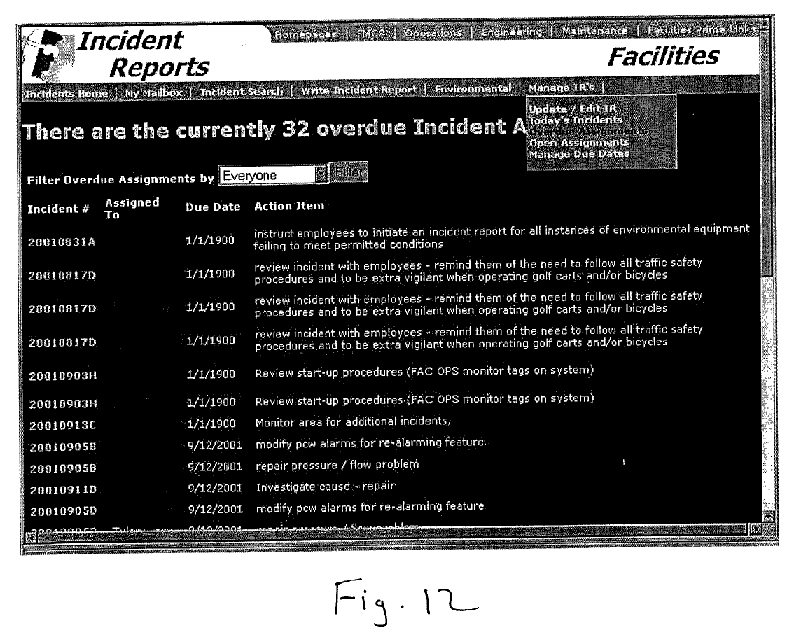

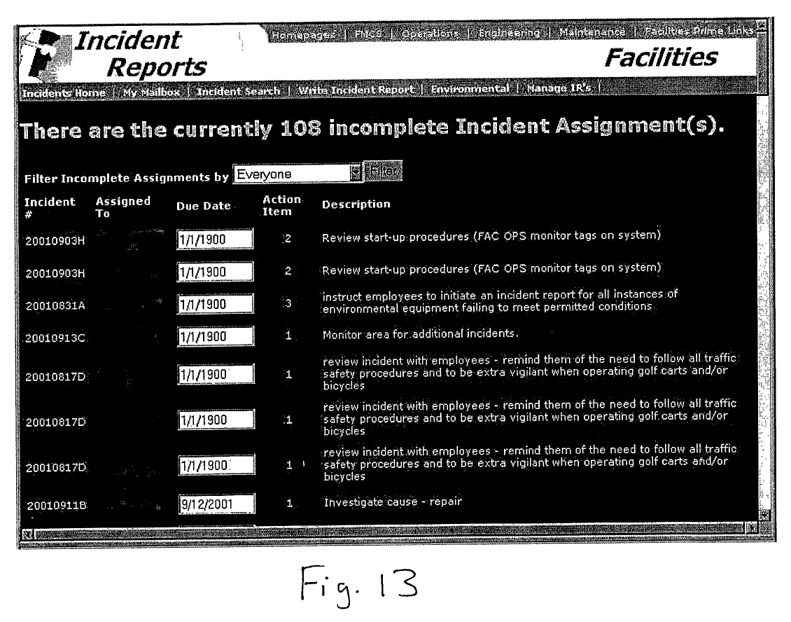

Other listings of incident reports are commonly required, and it is therefore helpful to provide quick listings of certain incidents with commonalties without resorting to a manual search scheme. FIGS. 10 through 13 represents some of these listings, such as listing according to a particular person's required corrective action, as in FIG. 10; incidents reported today, as in FIG. 11; incidents that have corrective action that is overdue, as in FIG. 12; and incidents that have corrective actions that are not complete, as in FIG. 13. Each of these listings are provided by a single hypertext link which provides predefined search parameters rather than proceeding to a search page for manual entry. Additionally, a hypertext link may be associated with each listing to facilitate easy access to the respective incident report to obtain additional details. The format of the incident report listings is generally the same for each of the user interfaces 44, 48, 50, 52.

FIGS. 10 and 11 also represent an advantageous listing of incident reports relevant to a particular person according to the user login identification code. In FIG. 10, the computer network identifies the particular login identification code and provides only the incident reports relevant to the particular person associated with that code. For example, the supervisory authority may view incidents requiring their attention and the incident reports requiring the attention of subordinates. FIG. 11 lists incident reports without disclosing their contents or providing access. As such, these reports are restricted to viewing by certain personnel according to their login identification codes.

Therefore, the foregoing description provides a method and system 40 for reporting, assigning, and tracking facilities incident reports and described various embodiments in general and with particularity according to the present invention. In particular, the method and system 40 provide a single integrated approach to maintaining incident reports. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for reporting, assigning, and tracking facility incident reports, comprising:
receiving an incident report;
automatically providing an electronic report notification of the incident report to a supervisory authority;
classifying the incident according to an incident classification standard;
assigning corrective action to designated personnel;
automatically providing an electronic assignment notification of the incident report and assigned corrective action to each of the designated personnel; and
receiving a confirmation of completion of the assigned corrective action to the incident report by the designated personnel.

2. The method of claim 1, further comprising an additional step of reviewing the incident report by the supervisory authority after the step of automatically providing the electronic report notification to the supervisory authority.

3. The method of claim 2, further comprising an additional step of automatically providing a report notification of the incident report to an incident classification authority after the review by the supervisory authority, wherein the classification authority performs the classifying step.

4. The method of claim 1, wherein the incident classification standard is based upon a severity of harm caused as a result of the incident.

5. The method of claim 1, further comprising an additional step of storing the incident report in an electronic database.

6. The method of claim 5, further comprising an additional step of selectively limiting access to the electronic database by a plurality of selected personnel, wherein the selected personnel are selected from the group consisting of the supervisory authority, the designated personnel, and an incident classification authority.

7. The method of claim 5, further comprising an additional step of storing the incident classification in the electronic database.

8. The method of claim 7, further comprising an additional step of storing the assigned corrective action and designated personnel in the electronic database.

9. The method of claim 1, further comprising an additional step of completing the assigned corrective action by designated personnel after the step of automatically providing the electronic assignment notification.

10. The method of claim 1, further comprising an additional step of automatically providing a completed action notification of the incident report to the supervisory authority after the step of receiving the confirmation of completion.

11. The method of claim 10, further comprising an additional step of reviewing the completed assigned corrective action in the incident report by the supervisory authority after the step of automatically providing the completed action notification.

12. The method of claim 11, further comprising an additional step of determining whether an additional assignment of corrective action is required by the supervisory authority after reviewing the completed assigned corrective action, and if additional corrective action is required then also comprising repeating steps of assigning a corrective action, automatically providing an electronic assignment notification, and receiving a confirmation of completion.

13. The method of claim 1, wherein the step of classifying the incident includes classifying the incident with an incident classification standard according to an environmental incident reporting standard related to harm caused to the environment.

14. The method of claim 13, wherein the environmental incident reporting standard is a governmentally directed standard for use in reporting an environmental incident to a government authority.

15. The method of claim 1, wherein said assigning step further includes assigning a due date to designated personnel to complete corrective action and further comprising a step of providing an overdue notification to the designated personnel after the due date.

16. The method of claim 15, wherein said providing an overdue notification step includes providing an overdue notification to the supervisory authority.

17. A system for reporting, assigning, and tracking facility incident reports, comprising:
a computer network;
a computer database connected to said computer network;
an incident reporting user interface for receiving facilities incident reports and for transmitting the facilities incident reports via said computer network to said computer database;
a supervisory user interface for permitting review of the incident report, and for receiving the assignment of at least one corrective action and a designation of personnel to complete the assigned corrective action;
a corrective action user interface for permitting the designated personnel to review the incident report and to record completion of the assigned corrective action;
an incident classification user interface for permitting review of the incident report and for receiving a classification of the incident; and
a electronic notification generator to provide automatic notification of the incident report to a plurality of user interfaces, including a notification to the supervisory user interface and the incident classification user interface upon a receipt of a facility incident report, and a notification to the corrective action user interface upon the assignment of the corrective action and the designation of personnel.

18. The system of claim 17, wherein each user interface requires entry of a login identification code to limit access to the respective user interface.

19. The system of claim 18, wherein the computer database comprises a designated access list including a plurality of login identification codes, and wherein the user interfaces are responsive to the designated access list such that access to the incident reports requires entry of a login identification code from the designated access list.

20. The system of claim 17, wherein the computer network is selected from the group consisting of a local area network, a wide area network, and an intranet.

21. The system of claim 20, wherein at least one user interface comprises a personal computer.

22. The system of claim 20, wherein the notification generator provides notification in the form of an electronic mail document.

23. The system of claim 17, wherein the supervisory user interface provides for the recording of a due date for the assigned corrective action and the notification generator provides a notification to the corrective action user interface of the due date.

24. The system of claim 23, wherein the computer network comprises a processing element for sorting the incident reports having a due date which are past without any indication that the assigned corrective has been completed.

25. The system of claim 17, wherein the computer network comprises a processing element for sorting the incident reports according to a predefined parameter selected from the group consisting of an assigned incident number, a keyword in the incident report, a status of the incident report, an originator of the incident report, a location of the incident, a facility system related to the incident report, and a date of the incident report.

26. A method for reporting, assigning, and tracking facility environmental incident reports, comprising:
receiving an incident report;
automatically providing an electronic report notification of the incident report to a supervisory authority;
classifying the incident according to an environmental incident classification standard based upon the harm caused to the environment;
assigning corrective action to designated personnel;
automatically providing an electronic assignment notification of the incident report and assigned corrective action to each of the designated personnel; and
receiving a confirmation of completion of the assigned corrective action to the incident report by the designated personnel.

27. The method of claim 26, further comprising an additional step of reviewing the incident report by the supervisory authority after the step of automatically providing the electronic report notification to the supervisory authority.

28. The method of claim 26, further comprising an additional step of automatically providing a report notification of the incident report to an environmental incident classification authority, wherein the classification authority performs the classifying step.

29. The method of claim 26, further comprising an additional step of storing the incident report in an electronic database.

30. The method of claim 29, further comprising an additional step of selectively limiting access to the electronic database by a plurality of selected personnel, wherein the selected personnel are selected from the group consisting of the supervisory authority, the designated personnel, and an environmental incident classification authority.

31. The method of claim 29, further comprising an additional step of storing the incident classification in the electronic database.

32. The method of claim 31, further comprising an additional step of storing the assigned corrective action and designated personnel in the electronic database.

33. The method of claim 26, further comprising an additional step of completing the assigned corrective action by designated personnel after the step of automatically providing the electronic assignment notification.

34. The method of claim 26, further comprising an additional step of automatically providing a completed action notification of the incident report to the supervisory authority after the step of receiving the confirmation of completion.

35. The method of claim 34, further comprising an additional step of reviewing the completed assigned corrective action in the incident report by the supervisory authority after the step of automatically providing the completed action notification.

36. The method of claim 35, further comprising an additional step of determining whether an additional assignment of corrective action is required by the supervisory authority after reviewing the completed assigned corrective action, and if additional corrective action is required then also comprising repeating the steps of assigning a corrective action, automatically providing electronic an assignment notification, and receiving a confirmation of completion.

37. The method of claim 26, wherein the environmental incident classification standard is a governmentally directed standard for use in reporting an environmental incident to a government authority.

38. The method of claim 26, wherein said assigning step further includes assigning a due date to designated personnel to complete corrective action and further comprising a step of providing an overdue notification to the designated personnel after the due date.

39. The method of claim 38, wherein said providing an overdue notification step includes providing an overdue notification to the supervisory authority.
